(19) United States
(12) Patent Application Publication
(10) Pub. No.: US 2015/0107023 A1
(43) Pub. Date: Apr. 23, 2015

(54) ELECTRIC BED STRUCTURE

(71) Applicant: CHI-TZUNG HUANG, CHIAYI CITY (TW)

(72) Inventor: CHI-TZUNG HUANG, CHIAYI CITY (TW)

(21) Appl. No.: 14/057,256

(22) Filed: Oct. 18, 2013

(51) Int. Cl. A61G 7/015; A61G 7/018

(52) U.S. Cl. CPC A61G 7/015; A61G 7/018
USPC 5/614; 5/617

(57) ABSTRACT

An electric bed includes a base and an upper body adjustment unit is pivotably connected to a top portion of the base. A head support frame is pivotably connected to the upper body adjustment unit. A front adjustment unit has a power source located at the underside of the top portion of the base. An output end of the power source is connected to a push link and a support member. The push link is connected to the underside of the head support frame to tilt the head support frame. The support member is pivotably connected to the upper body support frame which has a support face. An angle is defined between the support face and the underside of the upper body adjustment unit. The head support frame is adjusted by using the front adjustment unit and the upper body support frame is then lifted to adjust the inclination.

### BACKGROUND OF THE INVENTION

1. Field of the Invention

The present invention relates to an electric bed, and more particularly, to an electric bed which allows the upper body support frame and head support frame to be adjusted.

2. Description of Related Art

The conventional patient beds are designed to allow the patient to sit or some desired poses for providing more comfortable experiences. The patient can therefore comfortably take medicines, read and eat. Generally, the conventional patient beds are composed of multiple boards which can be adjusted to desired angles to meet the above mentioned requirements.

Taiwan Patent No. I327900 discloses a patient bed composed of a base, a front support frame, a link unit, a rear support frame and a up-and-down frame wherein a mattress is put on the front support frame, the link unit, the rear support frame and the up-and-down frame so that the patient may line on the mattress. The base has two rails on two sides thereof and the link unit is movable on the rails. Two links are pivotably connected to two front ends of the two rails. The front support frame comprises a support link and two pivotal links are pivotably connected to the support link. A bar is connected between the two pivotal links. The bar has a curved arm extending backward therefrom and a first cylinder on the link unit is connected to the curved arm. Two connection links are connected to the middle portion of the link unit so that the first and second cylinders are respectively connected to two respective first sides of the two connection links. The two respective second sides of the two connection links each have a pivotal member, and the front support frame and the rear support frame are pivotably connected to the two pivotal members. The link unit has two H-shaped portions respectively extending from the front end and the rear end thereof, and each of the H-shaped portions is connected with a roller. The H-shaped portion on the rear end has a bottom pivotal member to which the up-and-down frame is connected which is co-moved with the link unit. The rear support frame and the up-and-down frame are connected to the pivotal members on the front end by links so as to be co-movable. The up-and-down frame has a contact link on the rear end thereof and the contact link has a top pivotal member. The bar of the rear support frame has a curved arm extending forward. The second cylinder is pivotably connected to the curved arm on the rear support frame. The rollers on the link unit are movably connected to the rails on the base so that the link unit is movable back and forth along the rails. The front and rear support frames are pivotably connected to the pivotal members on the front and rear connection links, so that the first and second cylinders are respectively connected to the two respective arms of the front and rear support frames. The up-and-down frame is pivotably connected to the rear support frame. The front section of the mattress is connected to the connection links.

Taiwan Utility Model No. M458960 discloses an electric patient bed and comprises a base having a fixed portion and a movable portion which is pivotably connected to the fixed portion. The fixed portion has a first face facing the movable portion, and a second face facing the fixed portion. The movable portion is movable between a matched position and a separated position relative to the fixed portion. When the movable portion is located at the matched position, it is parallel to the fixed portion, and the first face is located adjacent to the second face. When the movable portion is located at the separated position, it is not parallel to the fixed portion. A driving source is connected to the base so as to drive the movable portion to move relative to the fixed portion. An air bag is connected to one of the first and second faces, wherein the air bag has a hole and a speaker located in the hole.

Although the two patient beds are able to adjust the inclination angle, however, it is noted that the adjustments are focused on the upper body of the patient and cannot adjust the lower body independently. This cannot make the patient to feel comfortable.

The present invention intends to provide an electric bed structure which improves the shortcomings mentioned above.

### SUMMARY OF THE INVENTION

The present invention relates to an electric bed and comprises a base having a top portion located on the base. An upper body adjustment unit is pivotably connected to the front end of the top portion. A head support frame is pivotably connected to the front end of the upper body adjustment unit. A front adjustment unit has a power source located at the underside of the top portion of the base and an output end of the power source is connected to a push link and a support member. The push link is connected to the underside of the head support frame so as to tilt the head support frame. The support member is pivotably connected to the upper body support frame which has a support face. An angle is defined between the support face and the underside of the upper body adjustment unit, so that the support face lifts the upper body support frame to adjust the inclination.

Preferably, the power source of the front adjustment unit is one of a hydraulic cylinder and a pneumatic cylinder.

Preferably, multiple roller units extend upward from the base and the top portion is movable on the roller units. A connection link is connected between the push link and the base.

Preferably, the angle defined between the support face and the underside of the upper body adjustment unit is 10 degrees.

The primary object of the present invention is to provide an electric bed wherein the head support frame is adjusted by using the front adjustment unit. When the head support frame is adjusted to the desired position, the upper body support frame is then lifted to adjust the inclination. Therefore, the patient feel more comfortable by the present invention.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the electric bed of the present invention;

FIG. 2 is a side view to show the electric bed of the present invention;

FIG. 3 is a side view of the electric bed of the present invention, wherein the head support frame is adjusted to the desired position, and

FIG. 4 is a side view of the electric bed of the present invention, wherein the upper body support frame is adjusted to the desired position.

### DETAILED DESCRIPTION OF THE PREFERRED EMBODIMENT

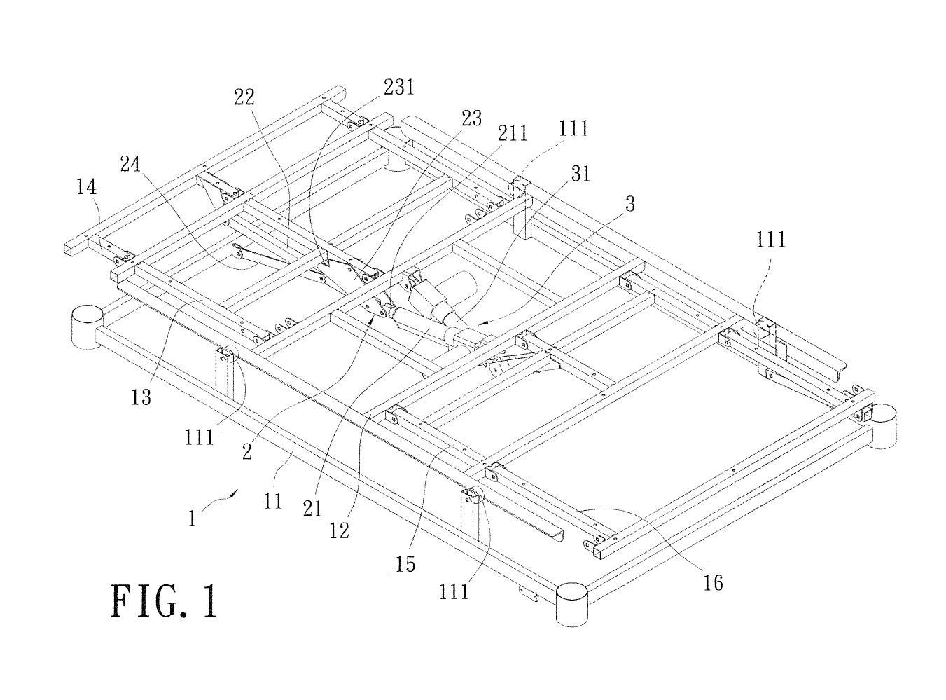

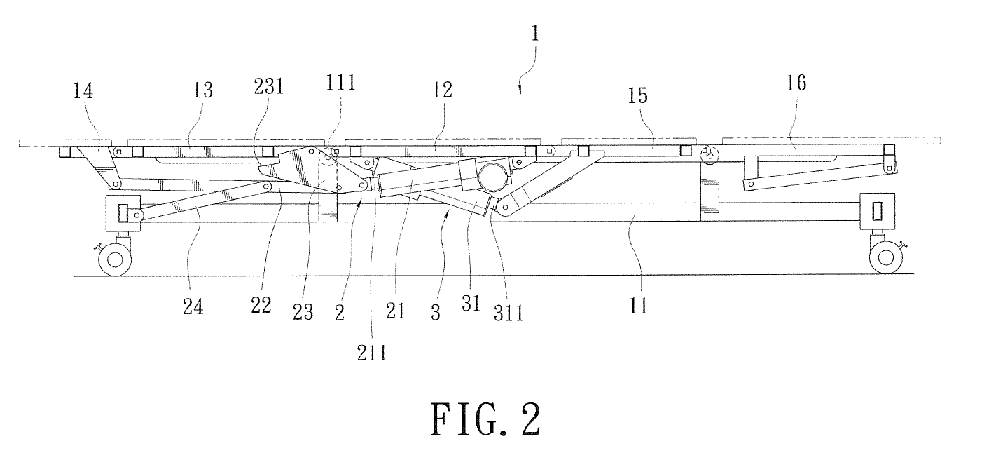

Referring to FIGS. 1 and 2, an electric bed 1 of the present invention comprises a base 11 having a top portion 12 located on the base 11. Multiple roller units 111 extend upward from the base 11 and the top portion 12 is movable on the roller units 111. An upper body adjustment unit 13 is pivotably connected to the front end of the top portion 12, and a head support frame 14 is pivotably connected to the front end of the upper body adjustment unit 13. A rear support frame 15 is pivotably connected to the rear end of the top portion 12. A movable frame 16 is pivotably connected to the rear support frame 15.

A front adjustment unit 2 has a power source 21 located at the underside of the top portion 12 of the base 11, wherein the power source 21 of the front adjustment unit 2 is one of a hydraulic cylinder and a pneumatic cylinder. An output end 211 of the power source 21 is connected to a push link 22 and a support member 23. The push link 22 is connected to the underside of the head support frame 14 so as to tilt the head support frame 14. A connection link 24 is connected between the push link 22 and the base 11. The support member 23 is pivotably connected to the upper body support frame 13 which has a support face 231. An angle defined between the support face 231 and an underside of the upper body adjustment unit 13. Preferably, the angle defined between the support face 231 and the underside of the upper body adjustment unit 13 is 10 degrees. The support face 231 lifts the upper body adjustment unit 13 to its desired position.

A rear adjustment unit 3 has a power source 31 located at the underside of the top portion 12 of the base 11. The power source 31 can be a hydraulic cylinder or a pneumatic cylinder. An output end 311 of the power source 31 is connected to the rear support frame 15 of the electric bed 1 so that the rear support frame 15 is driven by the power source 31 to change the inclination of the rear support frame 15.

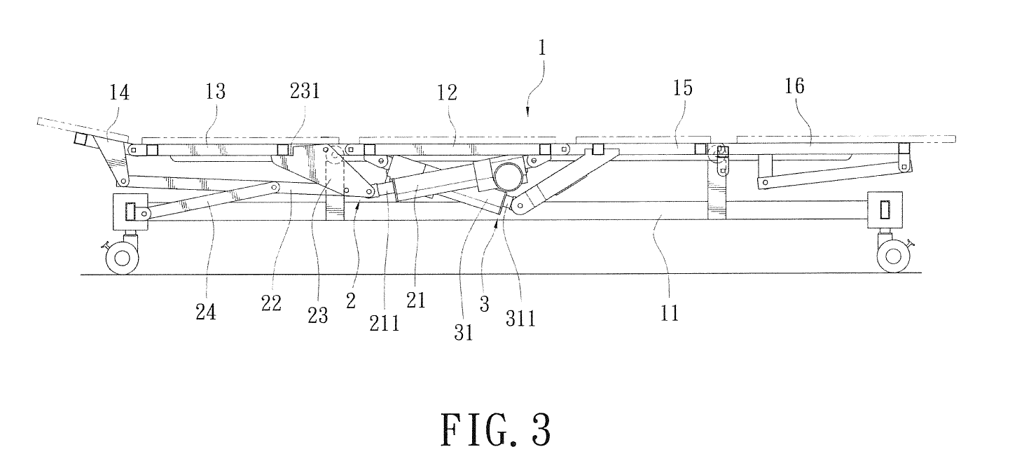

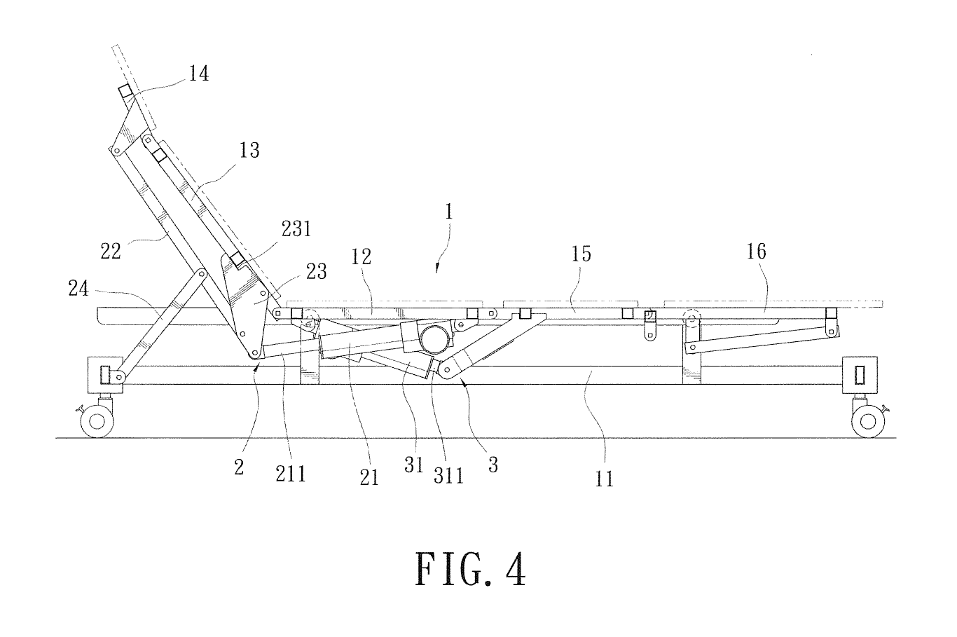

When the upper body of the patient is to be adjusted, the power source 21 of the front adjustment unit 2 is activated to output a force from the output end 211 which drives the push link 22 and the support member 23. The push link 22 pivots the head support frame 14 whose inclination is then changed as shown in FIG. 3. During the action of the push link 22, because there is a connection link 24 is connected between the push link 22 and the base 11, the top portion 12 is moved forward on the roller units 111. When the push link 22 pivots the head support frame 14 upward, the support member 23 is pivoted about the connection position between the bed 1 and the upper body support frame 13. Because there is an angle between the support face 231 and the underside of the upper body support frame 13, so that when the angle that the head support frame 14 is adjusted is the same as the angle between the upper body support frame 13 and the support face 231, the support face 231 starts to pivot the upper body support frame 13 to adjust the inclination of the upper body support frame 13 as shown in FIG. 4. In other words, the present invention allow the upper body support frame 13 and the head support frame 14 are respectively adjusted their inclination.

Compared with the conventional electric beds, the front adjustment unit 2 of the present invention is activated to adjust the head support frame 14, and when the angle that the head support frame 14 is adjusted to the desired angle, the upper body support frame 13 starts to be pivoted upward. Therefore, the upper body support frame 13 and the head support frame 14 can be respectively adjusted and this makes the patient feel comfortable.

While we have shown and described the embodiment in accordance with the present invention, it should be clear to those skilled in the art that further embodiments may be made without departing from the scope of the present invention.

1. An electric bed having independently adjustable forward and rear support portions, comprising:
a base having a top portion located thereon;
an upper body adjustment unit disposed in the forward support portion and pivotably connected to a front end of the top portion, a head support frame disposed in the forward support portion and pivotably connected to a front end of the upper body adjustment unit;
a front adjustment unit having a power source located at an underside of the top portion of the base, an output end of the power source connected to a push link and a support member, the push link connected to an underside of the head support frame to tilt the head support frame, the support member pivotably connected to the upper body adjustment unit, the support member having a support face, an angle defined between the support face and an underside of the upper body adjustment unit;
wherein the head support frame and upper body adjustment unit are pivotably displaceable responsive to the power source, the head support frame being separately displaceable relative to the upper body adjustment unit responsive to the power source.

2. The electric bed as claimed in claim 1, wherein the power source of the front adjustment unit is one of a hydraulic cylinder and a pneumatic cylinder.

3. The electric bed as claimed in claim 1, wherein multiple roller units are disposed elevated upward from the base, and the top portion is movable on the roller units, a connection link being connected between the push link and the base.

4. The electric bed as claimed in claim 1, wherein the angle defined between the support face and the underside of the upper body adjustment unit is approximately 10 degrees.
